(19) United States
(12) Patent Application Publication
(10) Pub. No.: US 2012/0030129 A1
(43) Pub. Date: Feb. 2, 2012

(54) HOSPITAL GUIDE SYSTEM AND METHOD FOR PROVIDING HOSPITAL GUIDE SERVICE

(75) Inventors: Gunhee Kim, Seoul (KR); Sungdo Ha, Seoul (KR); Se Hyung Park, Seoul (KR); Manchul Han, Seoul (KR); Ju Kyung Park, Daegu (KR); Hyun Chul Park, Gwangmyeong-si (KR); Seongil Lee, Seoul (KR); Jiho Choi, Suwon-si (KR)

(73) Assignee: KOREA INSTITUTE OF SCIENCE AND TECHNOLOGY, Seoul (KR)

(21) Appl. No.: 12/901,315

(22) Filed: Oct. 8, 2010

(30) Foreign Application Priority Data
Jul. 27, 2010 (KR) 1020100072498

(51) Int. Cl. G06Q 99/00

(52) U.S. Cl. 705/323

(57) ABSTRACT

Disclosed herein are a hospital guide system for providing guide information to a user in real time through a user terminal in comprehensive consideration of user's position information and user's medical treatment related information and a method for providing a hospital guide service. A hospital guide system includes a user position detecting unit that detects user's position information; a process storing unit that stores user's process information related to a service received by a user in a hospital; a guide information generating unit that decides a user's position-process based situation on the basis of the user's position information and the user's process information and generates guide information suitable for the user's position-process based situation; and a user terminal that provides the guide information to the user.

### CROSS-REFERENCE TO RELATED APPLICATION

This application claims priority from and the benefit of Korean Patent Application No. 10-2010-0072498, filed on Jul. 27, 2010, which is hereby incorporated by reference for all purposes as if fully set forth herein.

### BACKGROUND

1. Field of the Invention

Disclosed herein are a hospital guide system and a method for providing a hospital guide service, in which information necessary for each patient desired to receive medical services is provided to each of the patients in a hospital.

2. Description of the Related Art

It is not easy for a patient to know which service the patient is to receive and which place the patient is to visit to receive the corresponding service at a place such as a general hospital in which complicated services are provided. Also, it is not easy for a hospital official to manage medical treatment record information on a large number of patients and to guide a service suitable for each of the patient.

Conventionally, a method of establishing a database for information on patients was used to provide simple and systematical services in a hospital. That is, in a case where a patient visits a hospital, patient's personal information such as a name, a sex, an age and a resident registration number is provided through a document, and the provided personal information is inputted to a computer so as to establish a database. Also, a magnetic medical card having the patient's personal information recorded therein is provided to the patient. Thereafter, if the patient visits the hospital again, the patient's personal information is read through a card reader, and a medical service is provided to the patient with reference to a patient's past medical treatment record and the like.

However, although the aforementioned method is used, it is very inconvenience in that each patient necessarily contacts its magnetic medical card with the card reader so as to read its related information, and a user necessarily receives a guide related to medical services again through an information guide system.

### SUMMARY OF THE INVENTION

Disclosed herein are a hospital guide system for providing patients with position information, process information and the like in real time in a hospital in which the patients necessarily perform complicated affairs to receive medical treatment, and a method for providing a hospital guide service.

In one embodiment, there is provided a hospital guide system including: a guide information generating unit that generates guide information to be provided to a user and provides the generated guide information to a user terminal; a user position detecting unit that detects user's position information using signal information received from the user terminal; and a process storing unit that stores process information related to a service received by the user in a hospital, wherein the guide information generating unit decides a user's position-process based situation using the user's position information detected from the user position detecting unit and the user's process information received from the process storing unit, and generates guide information suitable for the decided user's position-process based situation and then transmits the generated guide information to the user terminal.

The signal information received from the user terminal may include one or more of RFID signal information, ultrasonic signal information, Wi-fi signal information, Bluetooth signal information and GPS signal information. The user position detecting unit may detect user's approximate position information with a wide area using the RFID signal information or Wi-fi signal information, and detect user's exact position information using the RFID signal information, Bluetooth signal information or ultrasonic signal information.

The user's process information may include one or more of a user's disease and information on the user's disease, user's medical treatment reservation information, user's examination reservation information, user's reception information and user's acceptance information.

The guide information generating unit may include a communication module that transmits/receives signal information to/from the user position detecting unit, the process storing unit and the user terminal; a knowledge management unit that searches and deduces knowledge information corresponding to a user's position or process using a knowledge model defined by correlation between the user's position information and the user's process information; a situation decision unit that decides the user's position-process based situation on the basis of the user's position information and the user's process information, received through the communication module, and the knowledge information corresponding to the user's position or process received from the knowledge management unit; and a guide information determination unit that determines guide information to be provided to the user on the basis of the user's position-process based situation received from the situation decision unit.

In one embodiment, there is provided a method for providing a hospital guide service, the method including: receiving user's position information and user's process information related to a service received by a user in a hospital at every certain period; deciding a user's position-process based situation using the received user's position information and user's process information; deciding whether or not it is necessary to provide new guide information to the user on the basis of the decided user's position-process based situation; and determining guide information suitable for the user's position-process based situation and providing the determined guide information to the user, when it is decided that it is necessary to provide the new guide information to the user.

The user's process information may include one or more of a user's disease and information on the user's disease, user's medical treatment reservation information, user's examination reservation information, user's reception information and user's acceptance information. The guide information may be provided to the user using an interface suitable for a user's physical or metal state obtained from the user's process information.

The guide information may include one or more of user's process information, position guide information, direction guide information and notice guide information including calling information of a hospital employee.

### BRIEF DESCRIPTION OF THE DRAWINGS

The above and other aspects, features and advantages disclosed herein will become apparent from the following description of preferred embodiments given in conjunction with the accompanying drawings, in which:

FIG. 1 is a schematic configuration view of a hospital guide system according to an embodiment;

FIG. 2 is a schematic configuration view of a knowledge model applied to the hospital guide system according to the embodiment;

FIG. 3 is a view illustrating an operation of deciding a user's current position-process based situation and then determining a user process using the knowledge model applied to the hospital guide system according to the embodiment;

FIG. 4 is a flowchart illustrating operations of the hospital guide system according to the embodiment;

FIG. 5 is a view showing an example of the screen on which a user terminal provides process guide information in the hospital guide system according to the embodiment;

FIG. 6 is a view showing an example of the screen on which a user terminal provides position guide information in the hospital guide system according to the embodiment; and

FIG. 7 is a view showing an example of the screen on which a user terminal provides a notice guide service in the hospital guide system according to the embodiment.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

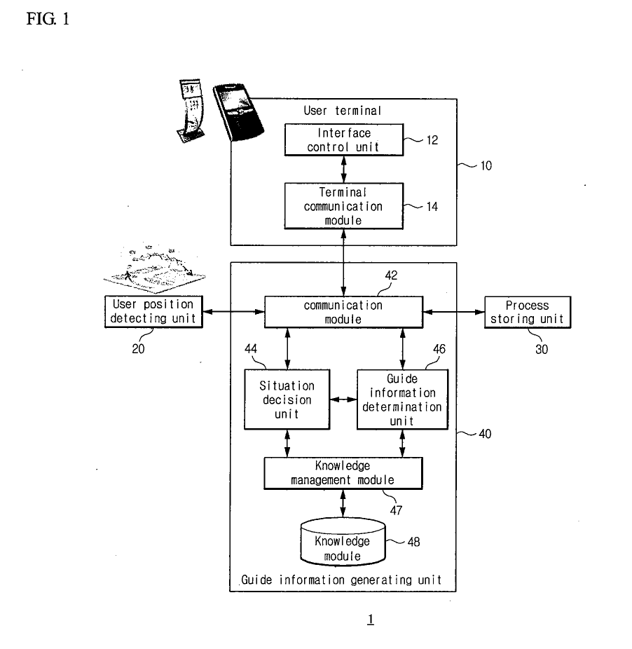

FIG. 1 is a schematic control block diagram of a hospital guide system according to an embodiment.

The hospital guide system 1 according to the embodiment includes a user position detecting unit 20 that receives a signal from a user terminal 10 and detects a user's position form information included in the signal, a process storing unit 30 and a guide information generating unit 40. As shown in FIG. 1, the user terminal 10 applicable to the hospital guide system 1 according to the embodiment an interface control unit 12 and a terminal communication module 14. The guide information generating unit 40 includes a communication module 42, a situation decision unit 44, a guide information determination unit 46, a knowledge management module 47 and a knowledge model 48. Here, ‘users’ means all customers who use a hospital, and a user refers to a person who receives various types of hospital guide information from the user terminal 10.

The user terminal 10 is a device that functions to provide various types of guide information received from the guide information generating unit 40. The user terminal 10 may include a mobile terminal such as a smart phone or a PDA and a fixed terminal such as a kiosk or an embedded display device mounted on a wall. The mobile terminal and the fixed terminal may be driven together. That is, any device that can provide various types of information to the user using such a mobile or fixed terminal may be used as the user terminal 10 communicated with the hospital guide system 1. The user terminal 10 shown in FIG. 1 will be described as an example.

The terminal communication module 14 in the user terminal 10 functions to transmit/receive various types of signal information to/from the communication module 42 which will be described later, and the interface control unit 12 functions to provide the guide information received through the terminal communication module 14 as information suitable for a user's situation. That is, the interface control unit 12 may display the guide information as an image on a display unit (not shown) provided to the user terminal 10, may provide the guide information as a sound or voice through a speaker (not shown), or may provide the guide information as vibration or light using such as a LED.

The user position detecting unit 20 functions to recognize and stores a user's position. The user position detecting unit 20 includes a sensor network system and a middleware. The sensor network system that exists at each agency senses a user's position or motion, and the sensed data is converted into information through the middleware. Then, the converted information is provided to the guide information generating unit 40. The sensor network system may be constructed using one or more of an RFID sensor module, an ultrasonic sensor module, a Wi-fi module, a Bluetooth module and a GPS module.

The most basic construction method is a method of attaching an RFID tag to the user terminal 10 and installing RFID readers and antennas in several places in a hospital. In this instance, the user terminal 10 may be a mobile terminal such as a portable smart phone. If a user moves while carrying the user terminal 10, the RFID readers and the antennas installed in the several places may read information of the RFID tag attached to the user terminal 10, thereby recognizing a user's position. However, according to the scale of the hospital, there may be used a method of attaching an RFID reader to the user terminal 10 and installing RFID tags in several places in a hospital, thereby recognizing a user's position.

Alternatively, an existing Wi-fi system may be used to recognize a user's approximate position, or a method of combining an RFID system with a narrow recognition area with an ultrasonic system and a Bluetooth system may be used to recognize a user's exact position. That is, user's approximate position information in a wide area may be obtained using the RFID or Wi-fi system, and user's exact position information in a narrow area may be obtained using the RFID, Bluetooth or ultrasonic system. For example, it may be recognized that the user's position is the ‘first floor of a building’ by using the Wi-fi system, and it may be recognized that the user's position is ‘in front of the reception desk’ by using the ultrasonic or Bluetooth system.

The process storing unit 30 stores whole process information on services that the user may receive or necessarily receives in the hospital, user's medical treatment reservation information, user's reception information, user's acceptance information, and the like. In order to obtain such information, the process storing unit 30 may obtain information by directly communicating with a hospital information system previously constructed in the hospital, or may directly store data of the hospital information system as an arbitrary database and call desired information from the database.

The process storing unit 30 transmits process event information on a user (e.g., reception completion, acceptance completion or the like) to the guide information generating unit 40. The process storing unit 30 includes the information system of each of the agencies and has basic position and process information for providing services to the user. For example, the position information contains the layout of the hospital building, information on the arrangement of sensors, and the like, and the process information contains information on the kind of affairs performed in each section, the flow of affairs managed by the agencies, and the like.

The process storing unit 30 standardizes user position information, process information and event information, which occur in various affairs managed by the agencies, in the form of XML, and transmits the standardized information to the guide information generating unit 40. Such information are converted by the knowledge management module 47 using the knowledge model 48 in the guide information generating unit 40, and are distributed to the situation decision unit 44 and the guide information determination unit 46. The information converted and distributed as described above enables a user's situation to be recognized in detail and enables the arrangement and adjustment of affairs to be effectively performed according to processes.

The guide information generating unit 40 functions to decide a user's position-process based situation on the basis of the user position information received from the user position detecting unit 20 and the information on the user's process, received from the process storing unit 30, and to generate guide information suitable for the user's position-process based situation and then transmit the generated guide information to the user terminal 10. In this instance, the ‘position-process based situation’ means a situation obtained by considering all the user's position and process. The position means information on a user's actual position in the hospital, and the process means information on which process the user currently goes through in the whole processes suitable for a user's disease. Hereinafter, the function of each of the components in the guide information generating unit 40 will be described in detail.

The communication module 42 functions to transmit/receive signal information to/from the user terminal 10, the user position detecting unit 20 and the process storing unit 30. That is, the communication module 42 functions to receive user position information from the user position detecting unit 20, to receive user process information from the process storage unit 30 and to transmit guide information generated on the basis of the user position information and the user process information to the user terminal 10.

The situation decision unit 44 decides a user's position-process based situation on the basis of the signal information received through the communication module 42 and the knowledge information corresponding to the user's position or process received from the knowledge management module 47. First, the operation of the knowledge management module 47 will be described below.

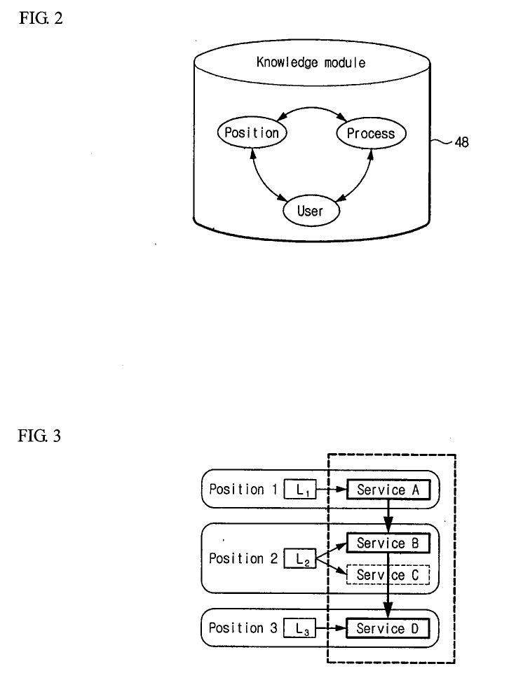

The knowledge management module 47 functions to search and deduce knowledge information corresponding to the user's position or process using the knowledge model 48 made based on position information and process information for each user and to provide information required by the situation decision unit 44. As shown in FIG. 2, knowledge (algorithm) related to user information, user's position information, user's process information is defined in the knowledge model 48. In this instance, user's process information is a concept including medical treatment related information such as user's reservation information in addition to user's entire process information. That is, the process information means a series of affairs to be performed or services to be received so as to achieve a user's object in the hospital. The process information is a flexible concept that may be changed by a user's object, an external fact, or the like. Information on a user's current position, an affair to be performed by the user in the process, a moving path, and the like are searched and deduced by the knowledge model 48, using the process information and the user's position information received from the user position detecting unit 20.

The knowledge management module 47 transmits the knowledge information searched and deduced using the knowledge model 48 to the situation decision unit 44, and the situation decision unit 44 decides the user's position-process based situation on the basis of the user's position information, the user's process information and the knowledge information. The operation of the situation decision unit 44 that decides the user's position-process based situation will be described below with reference to FIG. 3.

FIG. 3 is a view illustrating an operation of deciding a user's current position-process based situation and then determining a user process using the knowledge model applied to the hospital guide system according to the embodiment.

As illustrated in FIG. 3, the hospital guide system 1 according to the embodiment simultaneously considers user's position information and user's process information. Hence, the hospital guide system 1 may deduce a user's object and desired service based on the user's position, and may recognize a next destination and affair. Specifically, service A is provided at position 1, services B and C are provided at position 2, and service D is provided at position 3. However, the operation of a user's process is A→B→D. In a case where a user that receives the service A provided at the position 1 moves to the position 2, the hospital guide system 1 may decide that the service B of the services provided at the position 2 is a service desired by the user, and may provide position and medical treatment related information on the service B.

For example, if a patient whose medical treatment reservation is made is waiting at a public waiting seat in a medical office/reception window for first medical examination, the hospital guide system 1 may recognize that the patient is waiting for medical treatment. If a patient whose medical treatment reservation is not made is waiting at a public waiting seat in the medical office/reception window for first medical examination, the hospital guide system may recognize the situation in which the patient necessarily moves to the reception window for first medical examination rather than the medical office so as to make a medical treatment reservation. More specifically, the hospital guide system 1 may recognize that a user is positioned at a public waiting seat in the medical office/reception window for first medical examination through position information (coordinate value) and a position (specific service place) on the knowledge model 48, which corresponds to the position information, and may recognize current process information (waiting) and next process information (medical treatment or reception) in the entire process decided by the knowledge model 48. Thus, the situation decision unit 44 can decide that next process guide information is continuously provided to the user whose medical treatment reservation is made, and can provide guide information to the user whose medical treatment reservation is not made so that the user naturally moves to the reception window for first medical examination.

If the knowledge management module 47 decides the user's current situation by using the knowledge model 48 based on the request of the situation decision unit 44 in such a manner, the situation decision unit 44 provides user's situation information to the guide information determination unit 46. The guide information determination unit 46 determines guide information necessary for the user based on the user's situation information received from the situation decision unit 44, and provides the guide information to the user terminal 10. For example, the guide information determination unit 46 may determine that information is provided to the user. Here, the information includes information on the situation that the user's current process is progressed, information on affairs to be performed based on the user's object (service guide), information on detailed affairs to be performed by the user so as to receive a specific service (how to use, how to write, or the like), information on current ambient situation such as a waiting time, and the like.

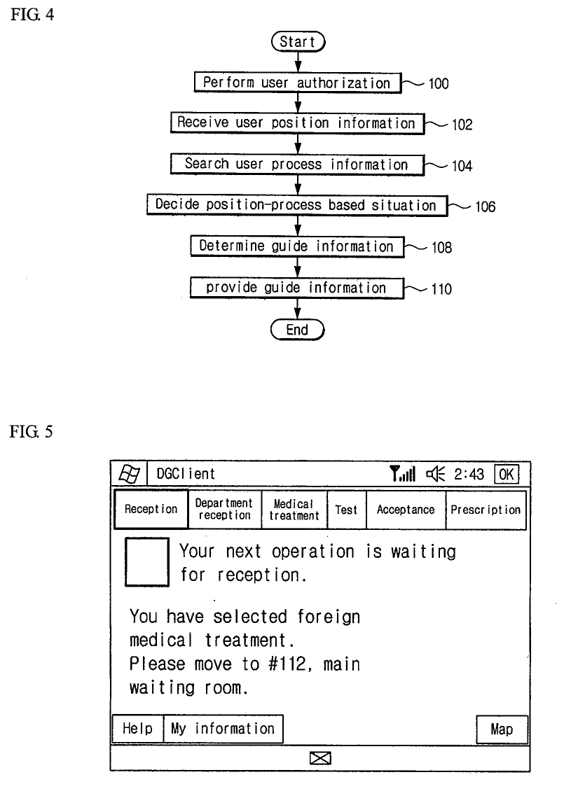

FIG. 4 is a flowchart illustrating operations of the hospital guide system according to the embodiment. The entire operation of the hospital guide system will be described with reference to FIG. 4.

If a user enters into a hospital having the user position detecting unit 20 installed therein while carrying the user terminal 10, a user authorization procedure is displayed on a screen of the user terminal 10 (100). The user authentication procedure may be performed using a method such as a method of inputting a user's identity (ID) and password or a fingerprint recognition method. The user authentication procedure is used to provide the user with an exact hospital guide service, to prevent personal data leakage, and the like. However, the user authentication procedure is not necessarily used, and may be omitted according to medical treatment service procedures of a hospital.

If the user authentication is completed, the user position detecting unit 20 receives user's position information using the user terminal 10 and position identification devices such as RFID tags and RFID readers installed at several places in the hospital (102). The user's position information is provided to the situation decision unit 44 or the guide information determination unit 46 through the communication module 42.

The guide information determination unit 46 receives user information received from the terminal communication module 14 of the user terminal 10 and searches user's process information corresponding to the authenticated user information through the process storing unit 30 (104).

The guide information determination unit 46 allows the situation decision unit 44 to decide a user's current position-process based situation on the basis of the user's position information and the user's process information. The situation decision unit 44 substitutes the user's position information and the user's process information for the knowledge management module 47 using the previously constructed knowledge model 48, thereby deciding the user's current position-process based situation (106).

The situation decision unit 44 transmits the user's position-process based situation to the guide information determination unit 46, and the guide information determination unit 46 determines guide information necessary for the user and then provides the guide information to the user terminal 10 (108). In this instance, signal information on a guide information transmission method related to user's physical or mental particular factors and the like in the user related information is also included in the guide information transmitted by the guide information determination unit 46. The interface control unit 12 in the user terminal 10 receives the signal information and provides each user with guide information by using the most effective method. For example, in a case where the user is a blind person, the interface control unit 12 may provide the blind person with the guide information through voice.

In such a manner, the guide information generating unit 40 receives the user information, the user's position information and the user's process information at every certain period from the user terminal 10, the user position detecting unit 20 and the process storing unit 30, and determines whether or not it is necessary to provide the user with new guide information. If it is determined that it is necessary to provide the user with the new guide information, the guide information generating unit 40 provides the user with the new guide information suitable for the user's position-process based situation through the user terminal 10.

The operation of the hospital guide system 1 according to the embodiment will be described below by assuming that a user makes a reservation by telephone or on-line and then enters into a hospital. If the user enters into the hospital, the user position detecting unit 20 recognizes that the user has entered into the hospital through an RFID tag attached to the user terminal 10 or an application such as Wi-fi or Bluetooth, installed in the user terminal 10, and provides it to the guide information generating unit 40.

The guide information generating unit 40 identifies the presence of the user's reservation through the process storing unit 30. The identified information is systemized as situation information, i.e., “the reserved user has entered into the hospital to receive medical treatment,” through the knowledge model 48. On the basis of the systemized situation information, the hospital guide system 1 provides a process guide, a position guide and a notice information guide according to the degree of progression of user's affair.

The process guide is used to guide information required in each service or affair operation in consideration of the user's entire process. The position guide is used to guide information on a current position, a next position to be moved and a path. The notice information guide is used to guide information displayed in the user terminal 10 in the form of a popup window when the user does not perform a process operation corresponding to the time point, when the user is not positioned at the corresponding place, when a hospital employee such as a nurse calls the user or sends a message to the user, or the like.

Hereinafter, hospital basic services will describe in detail how the hospital guide system 1 according to the embodiment recognizes a user's situation and provides a guide service to a user based on ‘reception/acceptance,’ ‘medical treatment’ and ‘examination,’ and ‘movement’ and ‘waiting’ for performing them.

(1) Receipt/Acceptance

\textcircled{1} The hospital guide system 1 recognizes that the user's current process is in a reception operation and the user's current position is in the vicinity of a reception desk (recognition of situation information).

\textcircled{2} The hospital guide system 1 decides that since the user has poor sight, the user has difficulty in filling out a reception form using the knowledge model 48 on the basis of such situation information (decision of position-process based situation).

\textcircled{3} The hospital guide system 1 receives user profile information necessary for filling out the reception form, transmitted from the process storing unit 30, on the basis of such spatiotemporal situation, and displays and guides the receive user profile information on a display unit of the user terminal 10 (transmission of guide information).

(2) Medical Treatment

\textcircled{1} In such a manner, the hospital guide system 1 recognizes that the user's current process is in a medical treatment operation and the user's current position is a medical office (recognition of situation information).

\textcircled{2} The hospital guide system 1 recognizes that the user needs to consult a doctor, and deduces that the user has difficulty in communicating with the doctor because the user has a bad sense of hearing and a deficient speaking and pronunciation ability (decision of position-process based situation).

\textcircled{3} The hospital guide system 1 provides picture communication cards, medical examination cards, or the like through the user terminal 10 so that the communication ability between the user and the doctor can be increased when the user consults the doctor (transmission of guide information).

(3) Examination

\textcircled{1} The hospital guide system 1 recognizes that the user's current process is in an examination operation and the user's current position is an examination room (recognition of situation information).

\textcircled{2} The hospital guide system 1 recognizes that the user needs to be fully aware of directions before receiving an examination, and deduces that the user has difficulty in being fully aware of the directions in the examination room due to user's lack of understanding, memory and concentration and then has difficulty in memorizing and performing the next examination posterior to the current examination (decision of position-process based situation).

\textcircled{3} The hospital guide system 1 stores guide information such as directions, and informs the user of the guide information for each process operation by using a popup window in the display unit of the user terminal 10 or by using a voice through a speaker of the user terminal 10. The hospital guide system 1 informs the user of the next process in the same manner in consideration of the current process (transmission of guide information).

(4) Waiting

\textcircled{1} The hospital guide system 1 recognizes that the user's current process is in a waiting operation and the user's current position is a waiting room (recognition of situation information).

\textcircled{2} The hospital guide system 1 recognizes that the user needs to extract a waiting number ticket and wait until an employee calls the user by name, and deduces that the user has difficulty in recognizing the user's own order from several number plates due to user's lack of sight, hearing and concentration. In a case where the number of waiting people prior to the user is less than three, the hospital guide system 1 deduces that if the user is out of the waiting room, the user needs to move to the waiting room (decision of position-process based situation).

\textcircled{3} The hospital guide system 1 guides a waiting person who does not extract a waiting number ticket to extract the waiting number ticket, and informs the user that the user's name is called using an additional function such as a sound when the user's name is called. In a case where the number of waiting people prior to the user is less than three, the hospital guide system 1 informs that if the user is out of the waiting room, the user needs to move to the waiting room (transmission of guide information).

(5) Movement

\textcircled{1} One service has been finished on the user's current process, and the hospital guide system 1 recognizes the next service (recognition of situation information).

\textcircled{2} The hospital guide system 1 deduces a next destination from information on the current and next services, and deduces a movement path from the current position to the next destination (deduction of movement path).

\textcircled{3} The hospital guide system 1 deduces that the user needs to move to the next destination, and deduces that in a case where stairs exist on the movement path, the user has difficulty in moving due to user's lack of athletic ability. In a case where the user has deficient understanding and space perception, the hospital guide system 1 deduces that the user has difficulty in understanding the movement path. In a case where the user has been previously out of a predetermined movement path, the hospital guide system 1 compares the user's position with the predetermined movement path and deduces that the user has been out of the predetermined movement path (decision of position-process based situation).

\textcircled{4} The hospital guide system 1 guides the user to a wheelchair path and an elevator. In a case where the user has been out of a predetermined movement path, the hospital guide system 1 guides the user to the predetermined movement path by expressing the predetermined movement path as a physical position that can be understood by the user (transmission of guide information).

The method in which the hospital guide system 1 according to the embodiment provides the user with guide information based on the aforementioned illustrative situations has been described. Accordingly, the user terminal 10 employs a method for providing a guide service so as to provide the user with guide information having a form easily understood by the user. The method of providing the guide service includes a process guide, a position guide and a notice information guide, which will be described with reference to FIGS. 5 to 7.

FIG. 5 is a view showing an example of the screen on which a user terminal provides process guide information in the hospital guide system according to the embodiment.

The user terminal 10 may include a smart phone, a PDA, a kiosk, an embedded display device and the like. Among them, a mobile terminal such as a smart phone, through which the position information of a user that carries the user terminal 10 can be easily obtained by attaching an RFID system to the user terminal 10, will be described as an example. The user terminal 10 provides brief information on a process that has been performed so far by schematizing the entire process, and an icon obtained by schematizing the entire process contains contents to be performed in respective operations. If necessary, the user may identify various types of information on a current screen of the user terminal 10 through a touch operation. That is, through the touch operation, the user may recognize a current operation on the process and obtain intuitive information on the next process on the process. Also, the user may receive detailed information for performing the current process.

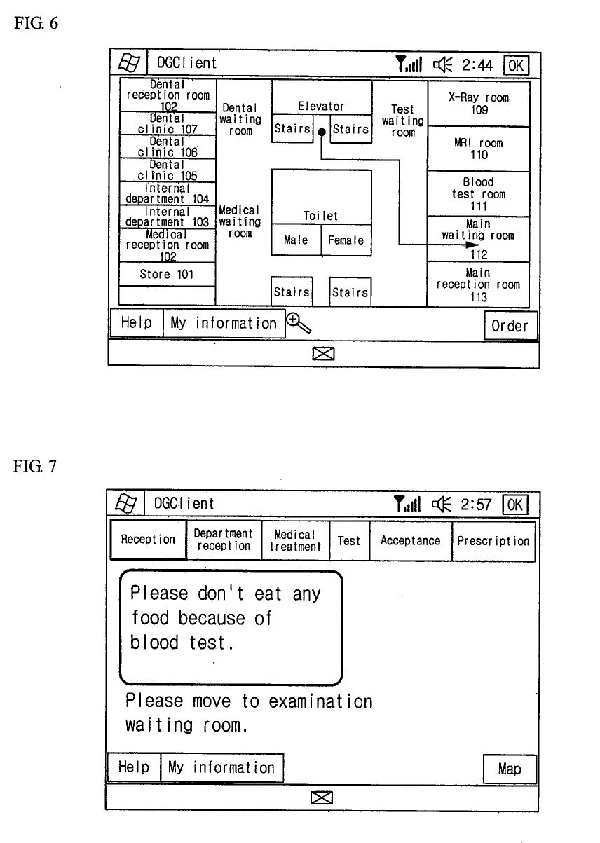

FIG. 5 shows a screen of the user terminal 10. ‘Reception-Department reception-Medical treatment-Examination-Acceptance-Prescription’ that is the entire process is displayed as an icon at an upper part on the screen, and ‘Reception’ that is a current process operation is displayed heavily, thereby displaying guide information in the reception operation. In FIG. 5, the information, i.e., ‘Please move to #112, main waiting room’ is provided to the user. The method of providing the user with position guide information related to the provided information will be described with reference to FIG. 6.

FIG. 6 is a view showing an example of the screen on which a user terminal provides position guide information in the hospital guide system according to the embodiment.

Referring to FIG. 6, a path along which the user can moves to #112, main waiting room is provided to the user through a map on a position guide screen. The position guide screen may be displayed when the user clicks icon ‘Map’ on the screen of FIG. 5 or when position guide information is provided to the user by predetermined algorithm.

On the screen of FIG. 6, an arrow is indicated from a point corresponding to the stairs as the user's current position to #112, main waiting room that is a target point. In this instance, landmark information easily recognized by the user may be displayed on the map displayed on the screen. The user's position and movement direction may be displayed in real time on the screen through an RFID sensor module, an ultrasonic sensor module, a Wi-fi module, a Bluetooth module, a GPS module, a directional sensor (terrestrial magnetism sensor), an acceleration sensor and the like, which are installed in the user terminal 10, so that the user can identify whether or not the user correctly moves through the movement path displayed on the screen and whether or not the user is out of the movement path displayed on the screen. If it is decided that the user is out of the movement path, notice information may also be provided to the user by using a vibration, sound, popup window or the like.

FIG. 7 is a view showing an example of the screen on which a user terminal provides a notice guide service in the hospital guide system according to the embodiment.

The notice information guide is used to inform the user of a problematic (unexpected) situation, a nurse's call or the like. If necessary, the notice information guide is provided to the user by using a popup window, vibration, sound or the like in the process that the user receives the process information guide or position information guide provided through the screen. The popup window or the like may disappear and return to a basic screen when a certain time elapses, when the displayed popup window is touched, or the like.

Referring to FIG. 7, the user may identify that directions is provided in the form of a popup window due to the nurse's call or the like in the process that the guide information i.e., ‘Please move to examination waiting room’ is provided to the user in operation ‘Examination’ out of the entire process. That is, when a blood test is expected to be performed, a notice message, i.e., ‘Please don't eat any food’ is provided to the user in a case where the user is positioned at a place at which the user may eat food, e.g., a food court, convenient store or beverage vending machine or where the user is in a time zone when it is highly likely that the user eats food, e.g., a lunch time. In this case, the message is displayed as a popup window in the user terminal 10.

Until now, a mobile terminal easily carried by the user has been described as the user terminal 10. However, as described above, a kiosk, embedded display device or the like, installed at several places in the hospital, may be used as the user terminal 10. In this instance, the mobile terminal, kiosk, embedded display device or the like may provide the user with guide information through a communication network, or interaction between interfaces of fixed terminals such as a mobile terminal and a kiosk may be performed using a wireless communication method such as a Bluetooth communication method.

In addition, the user terminal 10 may include an auxiliary function according to the user's type. A considerable number of users who visit a hospital are disabled people and senior citizens whose physical or metal abilities are slightly lower than those of average people. Also, there are many patients whose physical abilities are temporally lowered due to accidents. In consideration of information accessibility of such users, various methods for providing information may be applied to a user interface (UI). Accordingly, the hospital may apply the UI suitable for situation using an auxiliary UI for satisfying needs of various users. Representative UI modes applicable to the user terminal 10 are as follows.

First, users with poor sight may employ a ‘dark-change mode’. The ‘dark-change mode’ enables the users to well recognize information displayed on a screen using the color reversal that allows a dark portion to be bright and allows a bright portion to be dark on the screen of the user terminal 10. The ‘dark-change mode’ helps the users with poor sight to take well advantage of the hospital guide system 1.

Also, users with poor sight may employ a ‘magnification mode’. The ‘magnification mode’ helps a very old person having poor sight due to problems such as farsightedness to magnify only a user's interested portion on the screen through a simple operation. If the ‘magnification mode’ is cancelled, it returns to a basic screen.

Also, users who have very poor sight or lose their sight may employ a ‘text to speech (TTS) mode’. In a case where it is decided that a user's sight is very poor, information displayed on the screen by a user's operation or a predetermined algorithm is provided to the user using a sound or voice so that the user can auditorily recognize the information.

Also, users may employ a ‘user situation recognition mode’. A user's situation is recognized in real time by using a terrestrial magnetism sensor, acceleration sensor or the like, installed in the user terminal 10. If it is recognized that a user falls down or drops the user terminal, the ‘user situation recognition mode’ transmits signal information to a hospital employee positioned at a neighboring place so that the user can receive an appropriate help.

Through the aforementioned configuration and method, the hospital guide system 1 according to the embodiment can provide, in real time, users who visit a hospital with guide information on the basis of user's position information and information related to user's medical treatment through a user terminal.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A hospital guide system comprising:
a guide information generating unit that generates guide information to be provided to a user and provides the generated guide information to a user terminal;
a user position detecting unit that detects user's position information using signal information received from the user terminal; and
a process storing unit that stores process information related to a service received by the user in a hospital,
wherein the guide information generating unit decides a user's position-process based situation using the user's position information detected from the user position detecting unit and the user's process information received from the process storing unit, and generates guide information suitable for the decided user's position-process based situation and then transmits the generated guide information to the user terminal.

2. The hospital guide system according to claim 1, wherein the signal information received from the user terminal includes one or more of RFID signal information, ultrasonic signal information, Wi-fi signal information, Bluetooth signal information and GPS signal information.

3. The hospital guide system according to claim 2, wherein the user position detecting unit detects user's approximate position information with a wide area using the RFID signal information or Wi-fi signal information, and detects user's exact position information using the RFID signal information, Bluetooth signal information or ultrasonic signal information.

4. The hospital guide system according to claim 1, wherein the user's process information includes one or more of a user's disease and information on the user's disease, user's medical treatment reservation information, user's examination reservation information, user's reception information and user's acceptance information.

5. The hospital guide system according to claim 1, wherein the guide information generating unit comprises:
a communication module that transmits/receives signal information to/from the user position detecting unit, the process storing unit and the user terminal;
a knowledge management unit that searches and deduces knowledge information corresponding to a user's position or process using a knowledge model defined by correlation between the user's position information and the user's process information;
a situation decision unit that decides the user's position-process based situation on the basis of the user's position information and the user's process information, received through the communication module, and the knowledge information corresponding to the user's position or process received from the knowledge management unit; and
a guide information determination unit that determines guide information to be provided to the user on the basis of the user's position-process based situation received from the situation decision unit.

6. A method for providing a hospital guide service, method comprising:
receiving user's position information and user's process information related to a service received by a user in a hospital at every certain period;
deciding a user's position-process based situation using the received user's position information and user's process information;
deciding whether or not it is necessary to provide new guide information to the user on the basis of the decided user's position-process based situation; and
determining guide information suitable for the user's position-process based situation and providing the determined guide information to the user, when it is decided that it is necessary to provide the new guide information to the user.

7. The method according to claim 6, wherein the user's process information includes one or more of a user's disease and information on the user's disease, user's medical treatment reservation information, user's examination reservation information, user's reception information and user's acceptance information.

8. The method according to claim 6, wherein the guide information is provided to the user using an interface suitable for a user's physical or metal state obtained from the user's process information.

9. The method according to claim 6, wherein the guide information includes one or more of user's process information, position guide information, direction guide information and notice guide information including calling information of a hospital employee.
